(19) United States
(12) Patent Application Publication
(10) Pub. No.: US 2025/0296418 A1
(43) Pub. Date: Sep. 25, 2025

(54) SYSTEMS FOR A TRANSMISSION SYSTEM

(71) Applicant: Dana Belgium N.V., Brugge (BE)

(72) Inventors: Joachim VAN DINGENEN, Drongen (BE); Pier Paolo RINALDI, Arco (IT); Mark SLATER, Warwickshire (GB)

(21) Appl. No.: 18/615,872

(22) Filed: Mar. 25, 2024

(51) Int. Cl. B60K 1/02; B60K 17/02; B60K 17/08; B60K 17/28; B60K 25/00

(52) U.S. Cl. CPC B60K 1/02; B60K 17/02; B60K 17/08; B60K 17/28; B60K 2025/005

(57) ABSTRACT

Systems are provided for a drivetrain. In one example, a system includes a first electric motor configured to provide a first power to a power take-off (PTO) and a drive axle via a first two-speed gear arrangement, a second electric motor configured to provide a second power to the drive axle via a second two-speed gear arrangement, and a controller including computer-readable instructions stored on non-transitory memory thereof that when executed enable the controller to adjust the first power of the first electric motor based on the second power.

### FIELD

The present description relates generally to a power take off (PTO) lay-out in a transmission system of an at least partially electric vehicle.

### BACKGROUND AND SUMMARY

Vehicles, including passenger vehicles, heavy-duty vehicles, off-highway vehicles, and the like are being equipped with electrified components in an effort to increase performance and reduce emissions. Electrification of vehicles may demand changes to existing architectures design to operate with an internal combustion engine. One example component that may be modified includes a power take off (PTO).

For example, electrified off-highway vehicles may be equipped with one or two electric motors. In the example of a single electric motor, the motor is sized to provide high torque at low speeds while being able to meet a maximum vehicle speed. These broad requirements may not be compatible with a single speed transmission, and thus the weight and packaging savings of using a single electric motor may be diminished via inclusion of a multi-speed transmission. If a single speed transmission is used, the single electric motor may be oversized such that its size is comparable or equal to two separate motors.

The issues described above may be addressed by a system including a first electric motor configured to provide a first power to a power take-off (PTO) and a drive axle via a first two-speed gear arrangement, a second electric motor configured to provide a second power to the drive axle via a second two-speed gear arrangement, and a controller including computer-readable instructions stored on non-transitory memory thereof that when executed enable the controller to adjust the first power of the first electric motor based on the second power.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of a vehicle system.

FIG. 2 shows a first example of a powertrain including two electric motors and a two-speed transmission.

FIGS. 3A and 3B show second and third examples, respectively of a powertrain including two electric motors and a two-speed transmission.

FIGS. 4A, 4B, 4C, and 4D show alternative embodiments of the first example with a power take-off (PTO) arranged in different locations.

FIGS. 5A, 5B, and 5C show alternative embodiments of the second and third examples with a PTO arranged in different locations.

FIGS. 6A, 6B, and 6C show alternative embodiments of the second and third examples with a PTO arranged in different locations.

FIG. 7 shows illustrates a hydraulic system coupled to the PTO.

### DETAILED DESCRIPTION

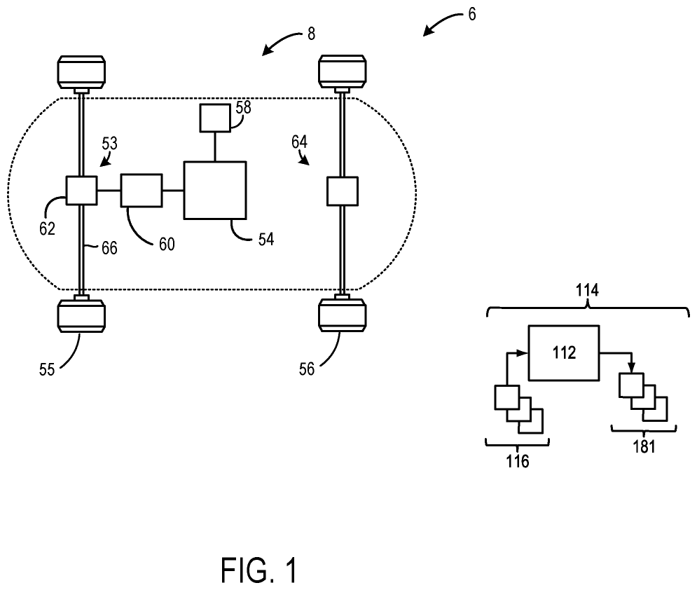

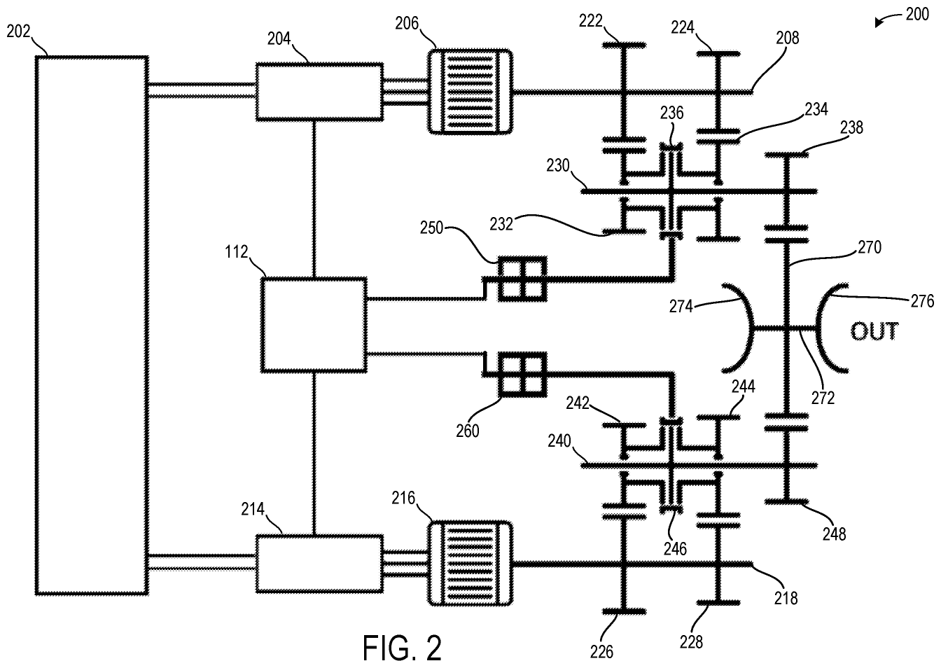

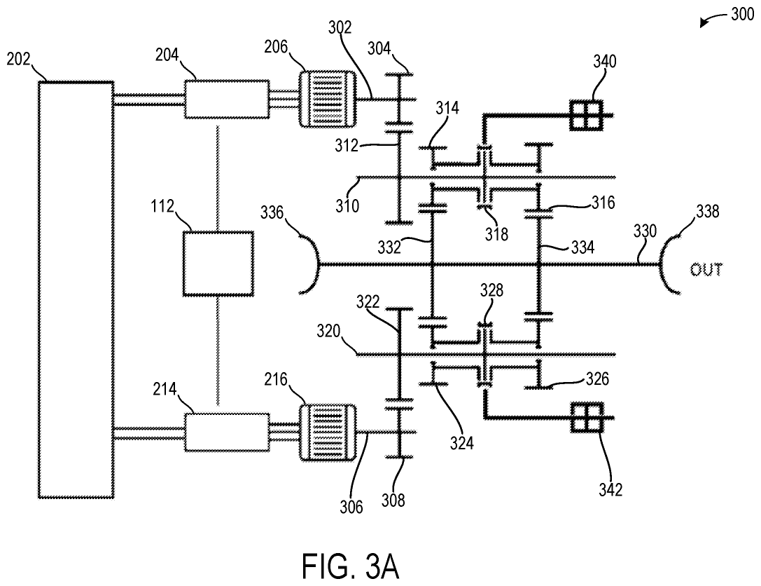

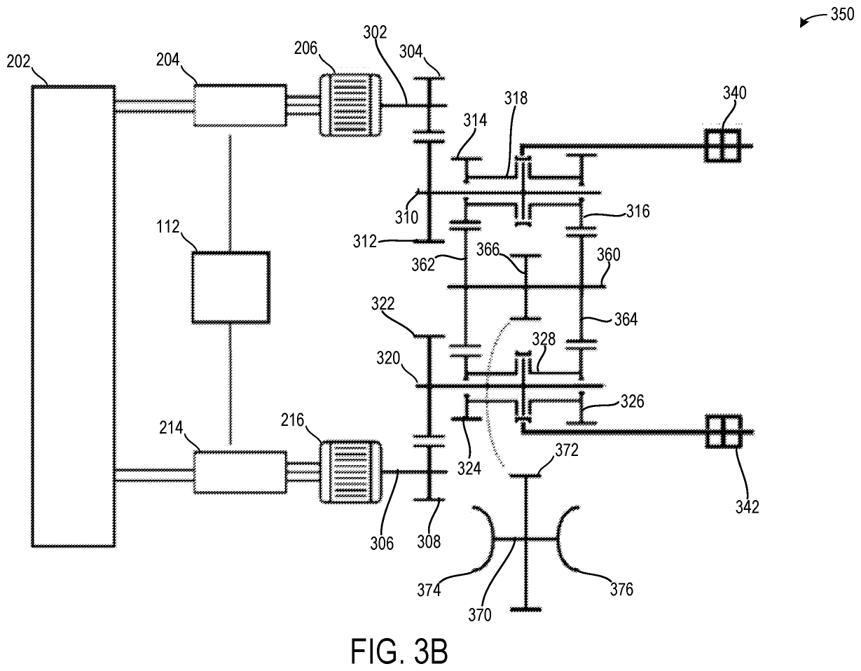

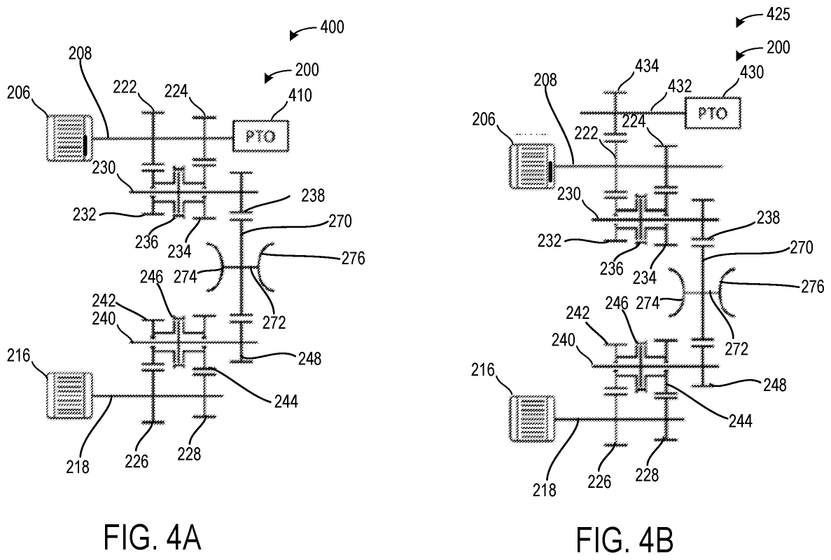

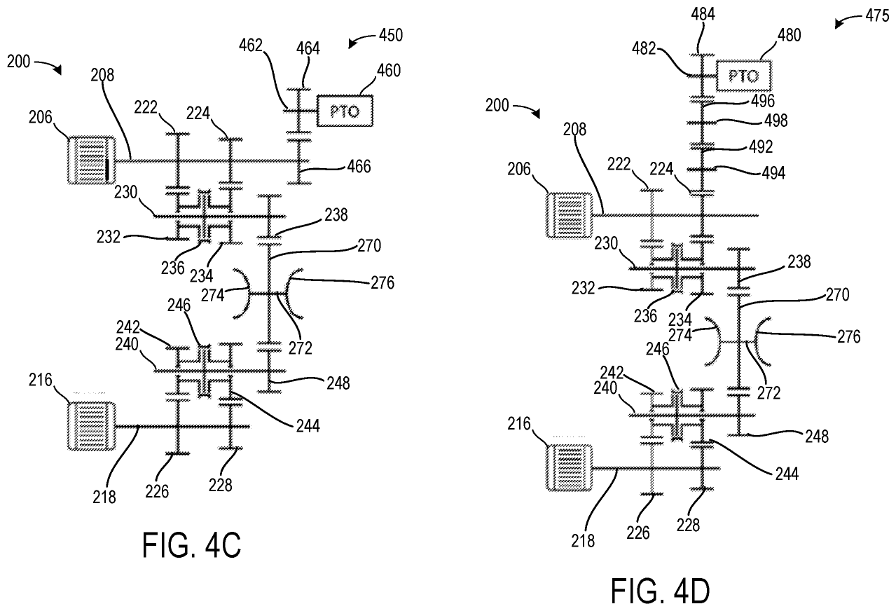

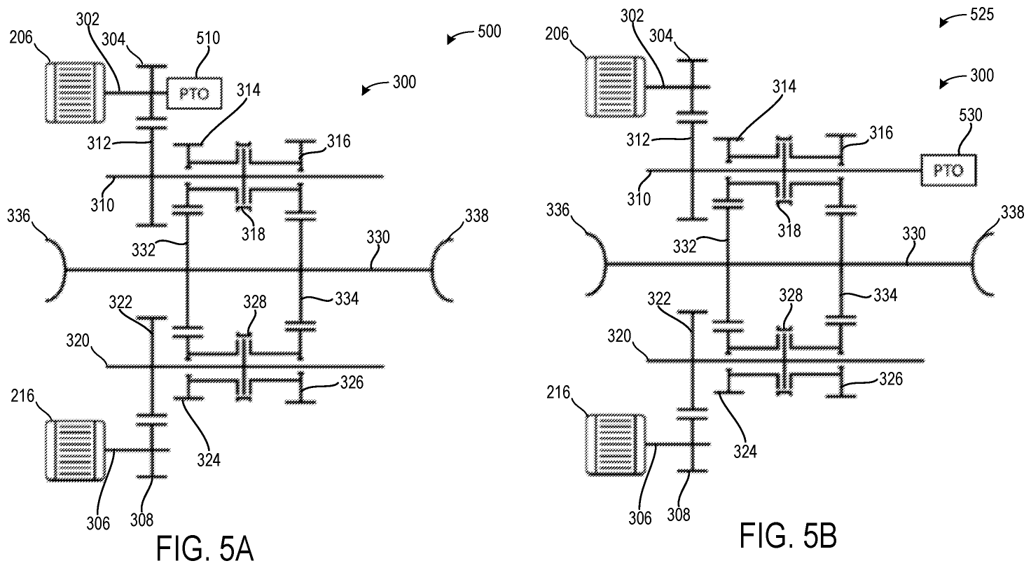

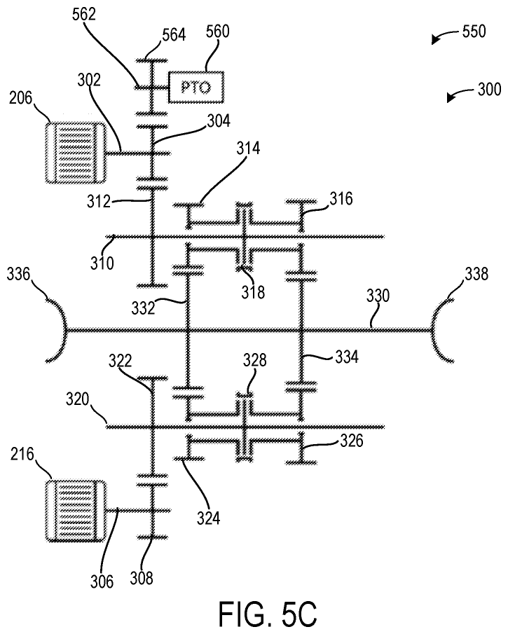

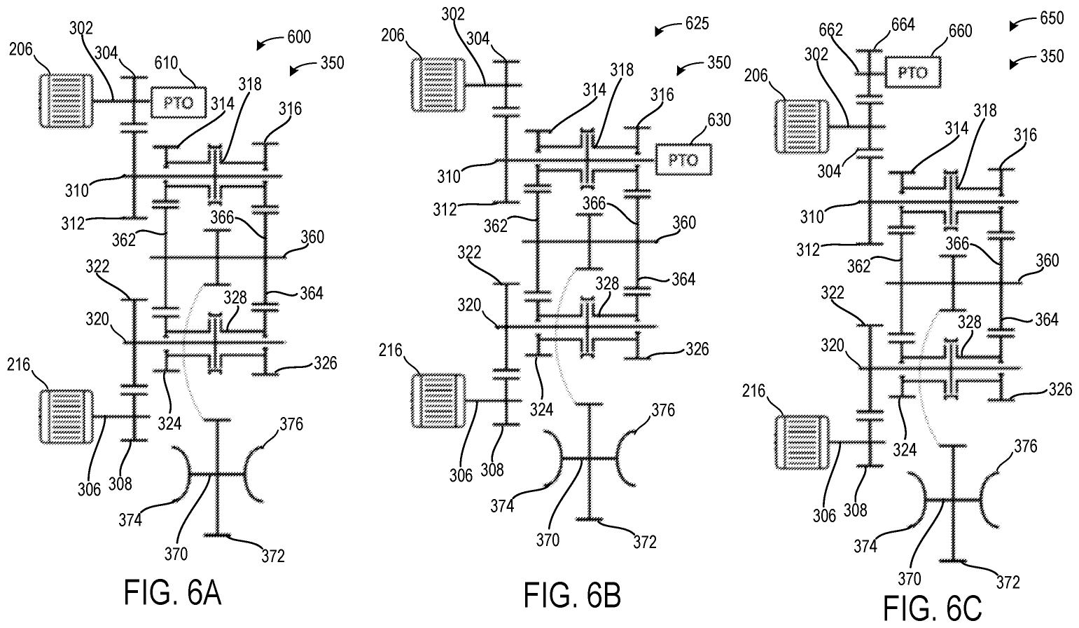

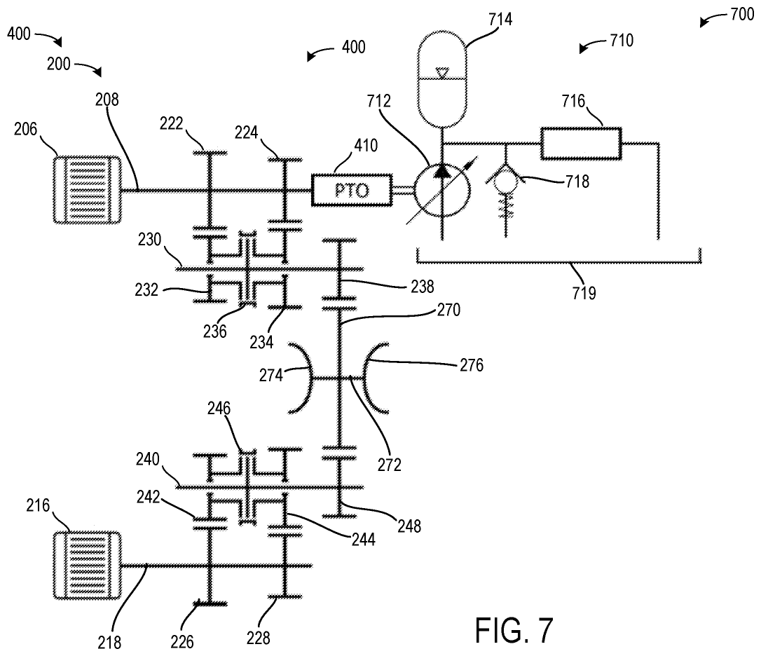

The following description relates to systems for a transmission system. The transmission system may be included in an electric powertrain of a vehicle. FIG. 1 shows an example of a vehicle comprising the transmission system. FIG. 2 shows a first example of a powertrain including two electric motors and a two-speed transmission. FIGS. 3A and 3B show second and third examples, respectively of a powertrain including two electric motors and a two-speed transmission. FIGS. 4A, 4B, 4C, and 4D show alternative embodiments of the first example with a power take-off (PTO) arranged in different locations. FIGS. 5A, 5B, and 5C show alternative embodiments of the second and third examples with a PTO arranged in different locations. FIGS. 6A, 6B, and 6C show alternative embodiments of the second and third examples with a PTO arranged in different locations. FIG. 7 shows illustrates a hydraulic system coupled to the PTO.

In one embodiment, the disclosure provides support for a system include where a PTO is permanently connected to one of the two motors of a dual electric motor, 2-speed seamless shifting transmission. The motor(s) may deliver power to a vehicle hydraulic circuit and to a vehicle driveline for traction. The motors may include a neutral state, so that power can be delivered solely to the hydraulic circuit when the vehicle speed is zero and a vehicle attachment is operated, such as a bucket, a forklift, or other attachment. For example, as in the case of a wheeled excavator, the two motors can peak their power with different speeds as requested in the case of the wheel loader entering the bucket in the pile. In the example of the reach-stacker, one motor can be dedicated to the traction for low-speed maneuvers and the second may provide power to the hydraulic circuit whereas, when the vehicle is travelling at full load and full speed, the two motors may provide almost all the available power for traction with one of them keeping a minimum hydraulic power for vehicle services. At shifting speeds, the demand for hydraulic power at the vehicle attachments is unlikely and the motor driving the PTO may assist the traction motor in shifting, which may provide a seamless shifting experience, thereby improving customer satisfaction and increasing transmission durability.

In an additional embodiment, a transmission architecture and a methodology to operate the transmission. A first electric motor may be connected to an output shaft via a first gear train including a first reduction ratio or via a second gear train including a second reduction ratio, smaller than the first reduction ratio. The selection between the two ratios may be executed by adjusting a first dog clutch. The dog clutch may provide a neutral state in addition to two engaged positions with respect to the first reduction ratio and the second reduction ratio. The two reduction ratios may be obtained in one or more stages. A second electric motor may be coupled to the output shaft via a third gear train including a third reduction ratio or via a fourth gear train including a fourth reduction ratio, smaller than the third reduction ratio. The selection between the two additional ratios may be executed by adjusting a second dog clutch that provides a neutral state in addition to the two engaged positions and further the two additional ratios may be obtained in one or more stages. Power flowing to the output shaft from the first motor follows a different and independent path from the power flowing to the output shaft from the second electric motor. The first electric motor shaft is permanently rotatably connected to a variable displacement volumetric pump via a power take off interface in direct connection to a pump shaft. The first electric motor, when disconnected from the output shaft, may deliver power to the pump demanded by the hydraulic circuit. The second electric motor, when connected to the output shaft via the third reduction ratio may deliver power to the output shaft demanded to meet a requested vehicle tractive effort. Furthermore, the second electric motor may be geared to the output shaft via the third reduction ratio to reach its maximum speed before or when the first electric motor geared to the output shaft via the first reduction ratio reaches its maximum speed. When the first electric motor is geared to the output shaft via the second reduction ratio and the second electric motor is geared to the output shaft by the fourth reduction ratio, the two motors may meet the vehicle cruising at any speed equal to or below the vehicle maximum speed at their nominal power. A method may include the first electric motor engaged to the output shaft when a positive vehicle speed above a threshold is occurring and disconnects the first electric motor below the threshold. When the first electric motor is engaged to the output shaft, the method balances the traction power between the two electric motors such that the power delivered by the first electric motor to the hydraulic circuit and to the output shaft is a certain percentage of its nominal power and the power delivered by the second electric motor to the output shaft is the same percentage of its nominal power.

In a further embodiment, the motors sizing is such that the second electric motor not connected to the hydraulic pump is capable, when geared with the third reduction ratio to the output shaft, of delivering alone the maximum vehicle tractive effort, eventually for a limited time span while peaking its performance.

The motors sizing is such that the first electric motor connected to the hydraulic pump, when not connected to the output shaft, can deliver alone all the demanded hydraulic power, eventually for a limited time span while peaking its performance.

The motors sizing is such that, when the vehicle is travelling at full speed and full load with minor implements usage, the power delivered by a single motor, eventually peaking its throughput, is not sufficient to indefinitely maintain the vehicle speed whereas using the two motors at nominal performance may maintain the vehicle speed.

Within the transmission, the two motors and their power electronics are identical in size, configuration, and power output capacity. When the two motor are both geared to the driveline, the traction power is shared between the two motors such that the second electric motor and the first electric motor are delivering the same percentage of their nominal power.

The transmission architecture of the present disclosure includes where travelling in the backward direction is obtained via reversing the rotation of the electric motor. Therefore, the first electric motor is not connected to the driveline for at low vehicle speeds below a lower threshold speed. When travelling in a reverse direction, a pump with a reverse flow feature may provide power to the hydraulic circuit. In such an example, the pump may be an axial piston hydrostatic unit with a swash plate. To give flexibility to the pump configuration, the first electric motor may be connected to the driveline for non-null and positive vehicle speed.

FIG. 1 shows a schematic depiction of a vehicle 6 with a powertrain 8 that may include a prime mover 54 and a transmission 60. The vehicle 6 may be a passenger vehicle, a commercial vehicle, a heavy-duty vehicle, an off-highway vehicle, an agricultural vehicle, a plane, a boat, or other vehicle system that utilizes lubricant.

The prime mover 54 may be electrically connected to an energy storage device 58 (e.g., one or more traction batteries, capacitors, fuel cells, combinations thereof, and the like). Further, the prime mover 54 may be configured to operate as a generator, during selected conditions, to provide electrical power to charge the energy storage device 58, for example.

In some examples, the vehicle 6 may include an internal combustion engine (ICE) configured to operate in combination with or independently of the prime mover 54. In this way, the vehicle 6 may be configured as a hybrid vehicle in some examples.

In the illustrated example, the transmission 60 delivers mechanical power to a differential 62 of an axle assembly 53. However, it will be appreciated that the transmission 60 may additionally or alternatively deliver mechanical power to the other axle 64 in the vehicle 6. Still further, in other examples, the transmission may be incorporated into one of the axles to form an electric axle assembly. In the electric axle example, an internal combustion engine may provide mechanical power to the other axle, in some cases.

The transmission 60 (e.g., a gearbox) may be configured to receive torque from the prime mover 54 via a shaft (e.g., a drive shaft) and/or other suitable mechanical components. The transmission 60 may output torque to the differential 62. The output torque may be moderated based on selective adjustments to gear engagement at the transmission 60 to accommodate desired vehicle operation. Torque from the transmission 60 may drive rotation of the differential 62, which may in turn drive rotation of axle shafts 66 which are rotationally coupled to vehicle wheels 55. Vehicle wheels 56 may rotate when vehicle wheels 55 are rotating against a surface.

A controller 112 may form a portion of a control system 114. The control system 114 is shown receiving information from sensors 116 and sending control signals to actuators 181. As one example, the sensors 116 may include sensors such as a battery level sensor, a clutch activation sensor, one or more positions sensors of the electric motor, etc. The controller 112 may receive input data from the sensors, process the input data via a processor, and trigger the actuators in response to the processed input data based on instruction or code programmed therein corresponding to one or more routines.

Turning now to FIG. 2, it shows an example of a system 200 including an energy storage device 202 coupled to a first inverter 204 and a second inverter 214. The first inverter 204 and the second inverter 214 may be controlled by the controller 112. As such, components previously introduced may be similarly numbered in this and subsequent figures.

The inverters may be controller to adjust an output of respective electric motors. More specifically, the first inverter 204 may be coupled to and configured to control an operation of a first electric motor 206. The second inverter 214 may be coupled to and configured to control an operation of a second electric motor 216.

A first electric motor shaft 208 may be coupled to and configured to rotate based on an operation of the first electric motor 206. The first electric motor shaft 208 may be parallel to a first axis. A first input gear 222 and a second input gear 224 are arranged on the first electric motor shaft 208. The first input gear 222 and the second input gear 224 may be configured to rotate when the first electric motor shaft 208 rotates. In one example, the first input gear 222 and the second input gear 224 are sized differently and may be included in a first two-speed gear arrangement.

A second electric motor shaft 218 may be coupled to and configured to rotate based on an operation of the second electric motor 216. The second electric motor shaft 218 may be parallel to a second axis. In one example, the second axis is parallel to the first axis. A third input gear 226 and a fourth input gear 228 are arranged on the second electric motor shaft 218. The third input gear 226 and the fourth input gear 228 may be configured to rotate when the second electric motor shaft 218 rotates. In one example, the third input gear 226 and the fourth input gear 228 are sized differently and may be included in a second two-speed gear arrangement. The first two-speed gear arrangement and the second two-speed gear arrangement may include helix or spur gears and are free of planetary gear sets.

The first electric motor 206 may be configured to provide a first power and the second electric motor 216 may be configured to provide a second power. In one example, an upper threshold first power may be equal to an upper threshold second power, wherein the upper threshold first and second power are based on non-zero, positive numbers corresponding to a maximum power of the electric motors. The first power and/or the second power may be adjusted based on operating condition of a vehicle including the system 200. In one example, the first power may be adjusted based on the second power.

A first intermediate shaft 230 may be parallel to a third axis. The third axis may be parallel to each of the first axis and the second axis. The first intermediate shaft 230 may include a first clutch gear 232 and a second clutch gear 234. The first clutch gear 232 may be in meshed engagement with the first input gear 222. The second clutch gear 234 may be in meshed engagement with the second input gear 224. A first clutch 236 may be configured to control an engagement and disengagement of the first clutch gear 232 and the second clutch gear 234 with the first intermediate shaft 230. The first intermediate shaft 230 may rotate when engaged with one of the first clutch gear 232 or the second clutch gear 234. When disengaged, the first intermediate shaft 230 may not rotate based on a rotation of the disengaged of the first clutch gear 232 and/or the second clutch gear 234.

A second intermediate shaft 240 may be parallel to a fourth axis. The fourth axis may be parallel to each of the first axis, the second axis, and the third axis. In this way, each of the shafts are parallel to one another without being coaxial, thereby decreasing a packaging size of the system 200. The second intermediate shaft 240 may include a third clutch gear 242 and a fourth clutch gear 244. The third clutch gear 242 may be in meshed engagement with the third input gear 226. The fourth clutch gear 244 may be in meshed engagement with the fourth input gear 228. A second clutch 246 may be configured to control an engagement and disengagement of the third clutch gear 242 and the fourth clutch gear 244 with the second intermediate shaft 240. The second intermediate shaft 240 may rotate when engaged with one of the third clutch gear 242 or the fourth clutch gear 244. When disengaged, the second intermediate shaft 240 may not rotate based on a rotation of the disengaged of the third clutch gear 242 and/or the fourth clutch gear 244.

A first intermediate shaft output gear 238 may be configured to rotate based on a rotation of the first intermediate shaft 230. The first intermediate shaft output gear 238 may be in meshed engagement with an output gear 270. The output gear 270 may be in meshed engagement with an output shaft 272 coupled to a first rotating component 274 and a second rotating component 276. The first rotating component 274 and the second rotating component 276 may be associated with separate wheels of a traction system.

A second intermediate shaft output gear 248 may be configured to rotate based on a rotation of the first intermediate shaft 240. The second intermediate shaft output gear 248 may be in meshed engagement with the output gear 270. The second intermediate shaft output gear 248 may be in meshed engagement with an opposite side of the output gear 270 relative to the first intermediate shaft output gear 238.

Controller 112 may adjust a position of the first clutch 236 and the second clutch 246 via a first active control torque module 250 and a second active control torque module 260, respectively. The first inverter 204 and the second inverter 214 may provide feedback to the controller 112 regarding operation of the first motor 206 and the second motor 216, respectively. The controller 112 may then adjust the position of the first clutch 236 and/or the second clutch 246 to change an engagement/disengagement of one or more of the gears between the electric motor shafts and the intermediate shafts.

Turning now to FIGS. 3A and 3B, they show alternative embodiments of a dual motor transmission. The embodiments of FIGS. 3A and 3B include the battery 202, first inverter 204, the second inverter 214, the first electric motor 206, and the second electric motor 216. As such, components previously introduced are similarly numbered in these and subsequent figures.

FIG. 3A shows a first alternative embodiment 300 of a dual motor transmission. The first electric motor 206 may include a first electric motor output shaft 302 including a first input gear 304. The first input gear 304 may be in meshed engagement with the first electric motor output shaft 302 and configured to rotate when the first electric motor output shaft 302 rotates. The first electric motor output shaft 302 is arranged along a first axis.

The second electric motor 216 may include a second electric motor output shaft 306. A second input gear 308 may be in meshed engagement with and configured to rotate when the second electric motor output shaft 306 rotates. The second electric motor output shaft is arranged along a second axis, parallel to the first axis.

A first intermediate shaft 310 may be in meshed engagement with a first intermediate shaft gear 312. The first intermediate shaft gear 312 may be in meshed engagement with the first input gear 304. When the first input gear 304 rotates, the first intermediate shaft gear 312 may also rotate, thereby rotating the first intermediate shaft 310. A first clutch gear 314 and a second clutch gear 316 may be coupled to a first clutch 318 and configured to engage or disengage with the first intermediate shaft 310. The first clutch 318 may be controlled via signals sent from the controller 112 to a first active control torque module 340. The first intermediate shaft 310 is arranged along a third axis, which is parallel to each of the first axis and the second axis.

A second intermediate shaft 320 may be in meshed engagement with a second intermediate shaft gear 322. The second intermediate shaft gear 322 may be in meshed engagement with the second input gear 308. When the second input gear 308 rotates, the second intermediate shaft gear 322 may also rotate, thereby rotating the second intermediate shaft 320. A third clutch gear 324 and a fourth clutch gear 326 may be coupled to a second clutch 328 and configured to engage or disengage with the second intermediate shaft 320. The second clutch 328 may be controlled via signals sent from the controller 112 to a second active control torque module 342. The second intermediate shaft 320 may be arranged along a fourth axis, which is parallel to each of the first axis, the second axis, and the third axis.

An output shaft 330 may be arranged along a fifth axis and parallel to each of the first electric motor output shaft 302, the second electric motor output shaft 306, the first intermediate shaft 310, and the second intermediate shaft 320. A first output gear 332 may be in meshed engagement with the output shaft 330 via a plurality of inner teeth. The first output gear 332 may be in meshed engagement with each of the first clutch gear 314 and the third clutch gear 324 with a plurality of outer teeth. A second output gear 334 may be in meshed engagement with the output shaft 330 via a plurality of inner teeth. The second output gear 334 may be in meshed engagement with each of the second clutch gear 316 and the fourth clutch gear 326 with a plurality of outer teeth. The output shaft 330 may rotate when at least one of the first output gear 332 or the second output gear 334 rotates. The output shaft 330 may be coupled to a first rotational component 336 and a second rotational component 338 such as wheels of a traction system.

Turning now to FIG. 3B, it shows a second alternative embodiment 350 of the dual motor transmission. The second alternative embodiment 350 may be substantially identical to the first alternative embodiment 300, except that the second alternative embodiment 350 includes a third intermediate shaft 360. A third intermediate shaft first gear 362 and a third intermediate shaft second gear 364 may be in meshed engagement with the third intermediate shaft 360 via a plurality of inner teeth. The third intermediate shaft first gear 362 may be meshed engagement with the first clutch gear 314 and the third clutch gear 324 via a plurality of outer teeth. The third intermediate shaft second gear 364 may be meshed engagement with the second clutch gear 316 and the fourth clutch gear 326 via a plurality of outer teeth. When one of the third intermediate shaft first gear 362 and/or the third intermediate shaft second gear 364 rotate, the third intermediate shaft 360 may also rotate, thereby rotating a third intermediate shaft third gear 366.

The third intermediate shaft third gear 366 may be in meshed engagement with an output gear 372 via a plurality of outer teeth. The output gear 372 may be in meshed engagement with and configured to rotate an output shaft 370 rotational coupled to a first rotational component 374 and a second rotational component 376.

The following figures and descriptions relate to various power take-off (PTO) locations in a dual motor transmission layout. The PTO may be used to drive a hydraulic circuit, as shown in FIG. 7. It will be appreciated that in each of the examples of FIGS. 2-7 the shafts of the dual motor transmission are parallel with one another without being coaxial.

Turning now to FIG. 4A, it shows an embodiment 400 illustrating a first example configuration of the system 200 including a PTO 410. The battery, inverters, controller, and active control torque modules are omitted for reasons of brevity. The PTO 410 may be directly coupled to the first electric motor shaft 208. In this way, when the vehicle is stationary and use of a vehicle device such as a bucket, fork, or other device is requested, substantially all the power from the first electric motor 206 may be used to power the PTO. The first clutch 236 may be actuated to disengage each of the first clutch gear 232 and the second clutch gear 234 from the first intermediate shaft 230 when substantially all power from the first electric motor 206 is provided to the PTO 410 and tractive power from the first electric motor 206 is not requested.

Turning now to FIG. 4B, it shows an embodiment 425 illustrating a second example configuration of the system 200 including a PTO 430. The second example configuration may be differentiated from the first example configuration of FIG. 4A in that the PTO 430 is coupled to a PTO shaft 432. A PTO shaft gear 434 may be in meshed engagement with the first input gear 222 arranged on the first electric motor shaft 208. In this way, the PTO shaft gear 434 may rotate when the first input gear 222 rotates, thereby rotating the PTO shaft 432 and powering the PTO 430.

Turning now to FIG. 4C, it shows an embodiment 450 illustrating a third example configuration of the system 200 including a PTO 460. The PTO 460 may be coupled to a PTO shaft 462 including a PTO shaft gear 464. The third example configuration may be differentiated from the second example configuration of FIG. 4B in that the PTO shaft gear 464 is coupled to a fifth input gear 466 arranged on the first electric motor output shaft 208.

Turning now to FIG. 4D, it shows an embodiment 475 illustrating a fourth example configuration of the system 200 including a PTO 480. The PTO 480 may be coupled to a PTO shaft 482 in meshed engagement with a PTO shaft gear 484. A first idler gear 492 may be arranged on a first idler gear shaft 494 and in meshed engagement with the second input gear 224. A second idler gear 496 may be arranged on a second idler gear shaft 498 and in meshed engagement with the first idler gear 492 and the PTO shaft gear 484. Thus, power flows from the first electric motor 206, through the first electric motor output shaft 208, through the second input gear 224, through the first idler gear 492, through the second idler gear 496, through the PTO shaft gear 484, through the PTO shaft 482, and to the PTO 480.

Turning now to FIG. 5A, it shows an embodiment 500 illustrating a first example configuration of the system 300 including a PTO 510. The battery, inverters, controller, and active control torque modules are omitted for reasons of brevity. The PTO 510 may be directly coupled to the first electric motor output shaft 302. In this way, when the vehicle is stationary and use of a vehicle device such as a bucket, fork, or other device is requested, substantially all the power from the first electric motor 206 may be used to power the PTO. The first clutch 318 may be actuated to disengage each of the first clutch gear 314 and the second clutch gear 316 from the first intermediate shaft 310 when substantially all power from the first electric motor 206 is provided to the PTO 510 and tractive power from the first electric motor 206 is not requested.

Turning now to FIG. 5B, it shows an embodiment 525 illustrating a second example configuration of the system 300 including a PTO 530. The second example configuration may differ from the first example configuration of FIG. 5A in that the PTO 530 is coupled to the first intermediate shaft 310. In this way, the PTO 530 is rotated via the first intermediate shaft 310. Operation of the first and second example configurations may be similar such that instructions stored in memory of a controller configured to operate the dual motor transmission may not be modified for a vehicle including the first example configuration or the second example configuration.

Turning now to FIG. 5C, it shows an embodiment 550 illustrating a third example configuration of the system 300 including a PTO 560. The third example configuration may differ from the first and second example configurations of FIGS. 5A and 5B, respectively, in that the PTO 560 is coupled to a PTO shaft 562. A PTO shaft gear 564 may be in meshed engagement with the PTO shaft 562 and the first input gear. When the first input gear 304 rotates, the PTO shaft gear 564 may also rotate, thereby rotating the PTO shaft 562 and transferring power to the PTO 560.

Turning now to FIG. 6A, it shows an embodiment 600 illustrating a first example configuration of the system 350 including a PTO 610. The battery, inverters, controller, and active control torque modules are omitted for reasons of brevity. The PTO 610 may be directly coupled to the first electric motor output shaft 302. In this way, when the vehicle is stationary and use of a vehicle device such as a bucket, fork, or other device is requested, substantially all the power from the first electric motor 206 may be used to power the PTO. The first clutch 318 may be actuated to disengage each of the first clutch gear 314 and the second clutch gear 316 from the first intermediate shaft 310 when substantially all power from the first electric motor 206 is provided to the PTO 610 and tractive power from the first electric motor 206 is not requested.

Turning now to FIG. 6B, it shows an embodiment 625 illustrating a second example configuration of the system 350 including a PTO 630. The second example configuration may differ from the first example configuration of FIG. 6A in that the PTO 630 is coupled to the first intermediate shaft 310. In this way, the PTO 630 is rotated via the first intermediate shaft 310. Operation of the first and second example configurations may be similar.

Turning now to FIG. 6C, it shows an embodiment 650 illustrating a third example configuration of the system 350 including a PTO 660. The third example configuration may differ from the first and second example configurations of FIGS. 6A and 6B, respectively, in that the PTO 660 is coupled to a PTO shaft 662. A PTO shaft gear 664 may be in meshed engagement with the PTO shaft 662 and the first input gear. When the first input gear 304 rotates, the PTO shaft gear 664 may also rotate, thereby rotating the PTO shaft 662 and transferring power to the PTO 660.

Turning now to FIG. 7, it shows an embodiment 700 illustrating a hydraulic system 710 coupled to the PTO 410 of the embodiment 400 of system 200. The hydraulic system 710 may include a pump 712 powered by the PTO 410. A pressure accumulator 714 may be configured to store and/or pressurize fluid provided by the pump 712. A pressure relief valve 718 may be arranged between the pump 712 and an actuator 716. The actuator 716 may be configured as a basket, a fork, a loader, or other device. Each of the pump 712, the pressure relief valve 718, and the actuator 716 is fluidly coupled to a reservoir 719 configured to store hydraulic fluid.

In one example, a pressure of the hydraulic circuit depends on a flow and on a circuit resistance, wherein the circuit resistance is proportional to user load (e.g., driver demand). Adjusting the power of the first motor may not affect the circuit pressure. Varying the speed of the pump 712 may adjust pressure in the hydraulic circuit.

A real-world example operation of the embodiment 700 is provided herein. The embodiment 700 is a wheel loader in the real-world example, however, other vehicles may be used and operated similarly. The operation describes a wheel loader entering a pile at an upper threshold torque and operating the implements to fill the bucket, reversing to withdraw from the pile, and shuttling to accelerate to its maximum speed in a full load condition.

When approaching the pile, at low vehicle speed, the first electric motor 206 is in a neutral state relative to the transmission such that neither of the first input gear 222 and the second input gear 224 are engaged and spinning to provide power to the hydraulic circuit via the PTO 410. In this phase, the first electric motor 206 is providing power to vehicle services (such as temperature control) and to the boom and bucket cylinders coupled to the hydraulic system 710. The second motor 216 is engaged to the second electric motor output shaft 218 with the fourth input gear 228 engaged thus providing a vehicle maximum tractive effort, which may include peaking a power of the second electric motor 216. In this phase, the second electric motor 216 may drive the vehicle to push the bucket further into the pile while the first electric motor 206 is used for actuation of the bucket.

Once the bucket is filled with a full load, the vehicle is requested to move backward. In this phase, the first electric motor 206 is providing hydraulic power to vehicle services while the second electric motor 216 is accelerating in the reverse direction.

When shuttling, the second electric motor 216 may decrease its speed to zero to move in forward direction with the first electric motor 206 providing its power to vehicle services and not to vehicle traction.

The vehicle is now increasing speed in the positive direction and, during a threshold exceeding event, such as decreasing below a lower threshold vehicle speed or increasing above an upper threshold vehicle speed, the first electric motor 206 may change its speed to synchronize the second output gear 224 to the first electric motor output shaft 208. The pump displacement may track the first electric motor 206 speed change to fulfill a hydraulic circuit request, namely increasing its displacement if the second electric motor 216 is slowing down or, conversely, reducing the pump displacement if the second electric motor 216 is speeding up and with the pressure storage reservoir eventually buffering identified mismatches in the pump yield. When synchronized, the controller may engage the second input gear 224 via actuation of the first clutch 236, and as a result, part of the traction load, originally demanded at only the second electric motor 216, is shifted to the first electric motor 206. During this operation the vehicle is continuing to seamlessly increase its speed such that the switch is not noticed by a vehicle operator.

When approaching the shifting speed, the traction load of the second electric motor 216 is zero and an entirety of the load is met by the first electric motor 206. At the shift point, the implement usage may be zero and loading the hydraulic circuit and the first electric motor 206 may meet the combined load of the traction system and the hydraulic pump (or pumps). At zero load, the fourth input gear 228 is disengaged via actuation of the second clutch 246 based on a command provided by the controller 112 to the second active control torque module 260 and the second electric motor 216 is in a neutral state towards the driveline. The second electric motor is therefore slowed to synchronize the driven gear of the third input gear 226 to its shaft. Once synchronized, the controller may signal to the second clutch via the second active torque control module to engage the third input gear 226. As such, a portion of the traction load, originally met via only the first electric motor 206, is shifted to the second electric motor 216. During this operation, the vehicle is continuing to seamlessly increase its speed.

Similar to that described above for the shifting of the second electric motor 216 branch where the tractive load is met with only the second electric motor 216. With zero traction load, the second input gear 224 is disengaged and the first electric motor 206 is in a neutral state towards the driveline. The second electric motor is therefore slowed to synchronize the first input gear 222 to the first electric motor output shaft 208 and the pump 712 may adjust its displacement to compensate the change in speed of the first electric motor 206 with the pressure accumulator 714 eventually buffering the hydraulic load. When synchronized, the controller may engage the first input gear 222 and as such, a portion of the traction load, met via only the second electric motor 216, is also met with the first electric motor 206. During this operation the vehicle is continuing to seamlessly increase its speed.

With the two motors engaged with the high ratio gears (e.g., the first input gear 222 and the third input gear 226), the vehicle continues to increase speed, eventually utilizing the peak capability of the motors. From this point onward, whichever cruising speed, including vehicle maximum speed, may be indefinitely sustained by the motors without overloading them.

The real-world example is used to provide one example as to how the architecture may be utilized. Additionally, reversing the sequence of the operations, a deceleration ramp may be similarly performed.

The disclosure also provides support for a system, comprising: a first electric motor configured to provide a first power to a power take-off (PTO) and a drive axle via a first two-speed gear arrangement, a second electric motor configured to provide a second power to the drive axle via a second two-speed gear arrangement, and a controller including computer-readable instructions stored on non-transitory memory thereof that when executed enable the controller to: adjust the first power of the first electric motor based on the second power. In a first example of the system, the PTO is permanently coupled to a shaft of the first electric motor. In a second example of the system, optionally including the first example, the PTO is permanently coupled to a gear of the first two-speed gear arrangement. In a third example of the system, optionally including one or both of the first and second examples, the PTO drives a pump of a hydraulic circuit. In a fourth example of the system, optionally including one or more or each of the first through third examples, the hydraulic circuit comprises an accumulator that adjusts a pressure of the hydraulic circuit when the first power is adjusted. In a fifth example of the system, optionally including one or more or each of the first through fourth examples, the first electric motor and the second electric motor are identical. In a sixth example of the system, optionally including one or more or each of the first through fifth examples, the PTO is coupled to only the first electric motor.

The disclosure also provides support for a drivetrain, comprising: a first electric motor configured to provide a first power to a power take-off (PTO) and a drive axle via a first two-speed gear arrangement, wherein a first clutch is configured to engage or disengage the first two-speed gear arrangement from the first electric motor, a second electric motor configured to provide a second power to the drive axle via a second two-speed gear arrangement, wherein a second clutch is configured to engage or disengage the second two-speed gear arrangement from the second electric motor, and a controller including computer-readable instructions stored on non-transitory memory thereof that when executed enable the controller to: adjust the first power of the first electric motor based on operation of a vehicle comprising the drivetrain. In a first example of the system, the first clutch and the second clutch are dog clutches. In a second example of the system, optionally including the first example, reduction ratios of the first two-speed gear arrangement are identical to reduction ratios of the second two-speed gear arrangement. In a third example of the system, optionally including one or both of the first and second examples, the PTO is coupled to a PTO shaft, wherein a PTO gear is meshed with the PTO shaft and a gear of the first two-speed gear arrangement. In a fourth example of the system, optionally including one or more or each of the first through third examples, the PTO operates a pump of a hydraulic circuit. In a fifth example of the system, optionally including one or more or each of the first through fourth examples, the hydraulic circuit comprises a pressure accumulator and an actuator configured to operate an accessory device. In a sixth example of the system, optionally including one or more or each of the first through fifth examples, the drive axle is coupled to wheels of an off-highway vehicle. In a seventh example of the system, optionally including one or more or each of the first through sixth examples, the first power and the second power are equal percentages of total power of the first electric motor and the second electric motor, respectively.

The disclosure also provides support for a system, comprising: a first electric motor configured to provide a first power to a power take-off (PTO) and a drive axle via a first two-speed gear arrangement, wherein a first clutch is configured to engage or disengage the first two-speed gear arrangement from the first electric motor, a second electric motor configured to provide a second power to the drive axle via a second two-speed gear arrangement, wherein a second clutch is configured to engage or disengage the second two-speed gear arrangement from the second electric motor, a hydraulic circuit comprising a pump coupled to the PTO, and a controller including computer-readable instructions stored on non-transitory memory thereof that when executed enable the controller to: adjust the first power of the first electric motor based on operation of a vehicle comprising the drivetrain. In a first example of the system, each shaft the system is parallel and not coaxial. In a second example of the system, optionally including the first example, gears of the first two-speed gear arrangement and the second two-speed gear arrangement are helix gears or spur gears. In a third example of the system, optionally including one or both of the first and second examples, the first electric motor supplies power to the PTO during all active operating conditions of the first electric motor. In a fourth example of the system, optionally including one or more or each of the first through third examples, the instructions cause the controller to one or more of adjust a power output of the first electric motor, the second electric motor, a position of the first clutch, and a position of the second clutch to adjust operating conditions.

FIGS. 2-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a first electric motor configured to provide a first power to a power take-off (PTO) and a drive axle via a first two-speed gear arrangement;
a second electric motor configured to provide a second power to the drive axle via a second two-speed gear arrangement; and
a controller including computer-readable instructions stored on non-transitory memory thereof that when executed enable the controller to:
adjust the first power of the first electric motor based on the second power.

2. The system of claim 1, wherein the PTO is permanently coupled to the shaft of the first electric motor.

3. The system of claim 1, wherein the PTO is permanently coupled to a gear of the first two-speed gear arrangement.

4. The system of claim 1, wherein the PTO drives a pump of a hydraulic circuit.

5. The system of claim 4, wherein the hydraulic circuit comprises an accumulator.

6. The system of claim 1, wherein the first electric motor and the second electric motor are identical.

7. The system of claim 1, wherein the PTO is coupled to only the first electric motor.

8. A drivetrain, comprising:
a first electric motor configured to provide a first power to a power take-off (PTO) and to a drive axle via a first two-speed gear arrangement, wherein a first clutch is configured to engage or disengage the first two-speed gear arrangement from the first electric motor;
a second electric motor configured to provide a second power to the drive axle via a second two-speed gear arrangement, wherein a second clutch is configured to engage or disengage the second two-speed gear arrangement from the second electric motor; and
a controller including computer-readable instructions stored on non-transitory memory thereof that when executed enable the controller to:
adjust the first power of the first electric motor based on operation of a vehicle comprising the drivetrain.

9. The drivetrain of claim 8, wherein the first clutch and the second clutch are dog clutches.

10. The drivetrain of claim 8, wherein reduction ratios of the first two-speed gear arrangement are identical to reduction ratios of the second two-speed gear arrangement.

11. The drivetrain of claim 8, wherein the PTO is coupled to a PTO shaft, wherein a PTO gear is meshed with the PTO shaft and a gear of the first two-speed gear arrangement.

12. The drivetrain of claim 8, wherein the PTO operates a pump of a hydraulic circuit.

13. The drivetrain of claim 12, wherein the hydraulic circuit comprises a pressure accumulator and an actuator configured to operate an accessory device.

14. The drivetrain of claim 8, wherein the drive axle is coupled to wheels of an off-highway vehicle.

15. The drivetrain of claim 8, wherein the first power delivered by the first motor and the second power delivered by the second motor are equal percentages of the total power of the first electric motor and of the second electric motor, respectively.

16. A system of a vehicle, comprising:
a first electric motor configured to provide a first power to a power take-off (PTO) and a drive axle via a first two-speed gear arrangement, wherein a first clutch is configured to engage or disengage the first two-speed gear arrangement from the first electric motor;
a second electric motor configured to provide a second power to the drive axle via a second two-speed gear arrangement, wherein a second clutch is configured to engage or disengage the second two-speed gear arrangement from the second electric motor;
a hydraulic circuit comprising a pump coupled to the PTO; and
a controller including computer-readable instructions stored on non-transitory memory thereof that when executed enable the controller to:
adjust the first power of the first electric motor based on operation of the vehicle.

17. The system of claim 16, wherein each shaft of the system is parallel and not coaxial to all the other shafts of the system.

18. The system of claim 16, wherein gears of the first two-speed gear arrangement and the second two-speed gear arrangement are helix gears or spur gears.

19. The system of claim 16, wherein the first electric motor supplies power to the PTO during all active operating conditions of the first electric motor.

20. The system of claim 16, wherein the pump is configured to adjust a pressure of the hydraulic circuit.
